(19) United States
(12) Patent Application Publication
(10) Pub. No.: US 2010/0044186 A1
(43) Pub. Date: Feb. 25, 2010

(54) Method and device for transport of a substrate

(75) Inventor: Markus Hlusiak, Bitterfeld-Wolfen (DE)

Correspondence Address: Markus Hlusiak, OT Wolfen, Oppenheimstrasse 4b, Bitterfeld-Wolfen, 06766, DE

(73) Assignee: Markus Hlusiak, Bitterfeld-Wolfen (DE)

(21) Appl. No.: 12/545,820

(22) Filed: Aug. 22, 2009

(30) Foreign Application Priority Data
Aug. 22, 2008 (DE) 102008041471.9

(51) Int. Cl. B65G 49/00; B65G 35/00; B65G 25/04; B65G 37/00

(52) U.S. Cl. 198/463.3; 198/617; 198/618

(57) ABSTRACT

Method and device for transport of a substrate 6 where the substrate is supported by one or several elongated transport elements 2 and is moved forwards in a substrate transport direction 22 by moving the elongated transport elements 2 and where the elongated transport elements 2 perform a shift in respect to the substrate 6 which is directed laterally to the substrate transport direction 22.

### BACKGROUND

### Field

This application relates to a method as well as to a device for the transport of a substrate.

### DETAILED DESCRIPTION

Methods for the transport of substrates are employed during the production of electronic components like e.g. solar cells for transporting the substrate from one process step to the next. It is also common to transport a substrate during a single process step. It is e.g. common to continuously move wafers inside a deposition chamber during a layer deposition step. One advantage thereof is that the deposited layer is more evenly distributed because possible inhomogeneities along the transport path are averaged out. Apart from this the whole production process can be designed continuously as transport within one process step can seamlessly pass over to transport between process steps. Such production methods which are advantageous for mass production are often called in-line methods.

During coating of a wafer as e.g. in a vapor deposition chamber it is common to transport the wafer by means of a frame-like carrier. Here the edges of the wafer rest on the supporting frame. Other transport methods carry the wafer through the process chamber on transport ribbons or wires. Such a method of transport is described in DE 100 597 77 A1. In this known method substrate transport is performed by using two pairs of wire-shaped transport elements. These elements move up and down and alternately support the substrate. The first pair of wires, while being in contact with the substrate moves it forwards in the direction of transport while the second pair moves backwards. After some time the wire pairs swap their role and the second pair supports and moves forwards the substrate while the first pair detaches from the substrate and moves backwards. This procedure is repeated in cycles. The disadvantage of the described transport methods is that the means of transport, both the frame-shaped carrier as well as the wire shaped transport elements, are positioned between the substrate and the vapor source. This causes them to shade part of the substrate. On this shaded part the deposition will be insufficient or even fully hindered.

Purpose of this application is to provide a device as well as a method for the transport of a substrate which reduces the effects of shading and enables a more homogenous and extensive substrate coating in a coating or layer deposition process.

This task is solved by a method according to claim 1 as well as by a device according to claim 16.

In detail this is done by moving the elements responsible for substrate transport relative to the substrate. This relative movement is directed laterally in regard to the direction of transport. This relative movement causes the part of the substrate surface which is shaded by the transport elements to move in respect to the substrate surface. This causes the missing deposition of the substrate surface to average out because permanent shading of one part of the substrate is prevented.

In this context “laterally in regard to the direction of transport” means that in vectorial consideration a component of movement perpendicular to the direction of transport exists. It is therefore not necessary for the relative movement of the transport elements to be entirely perpendicular to the direction of transport.

The invention is not restricted to coating or layer deposition methods but can be employed anywhere where a permanent occultation of part of a substrate during transport is to be prevented. This might e.g. be the case during transport by a fluid.

In a first embodiment the lateral movement of the elongated transport elements is performed stepwise. This means the lateral movement is performed in several succeeding steps which might be separated by breaks. The extent of the movement during a single step can be predetermined or be adjustable. If necessary the movement in transport direction can be stopped during the step of lateral movement.

In a modification of this embodiment the lateral movement of the elongated transport elements comprises a displacement movement. During this displacement movement the elongated transport elements are detached from the substrate. This detachment prevents the elongated transport elements from scratching along the substrate surface during the lateral movement. Furthermore the elongated transport elements may perform a backwards movement contrary to the direction of transport in addition to the lateral movement after detaching from the substrate. In this way the displacement movement enables decoupling the movements of substrate and transport elements.

In this embodiment the substrate can be placed onto one or several other elongated transport elements during the lateral movement of the elongated transport elements. The other elongated transport elements may be stationary or move along with the elongated transport elements.

A further modification of this embodiment comprises a pick-up step and a set-down step. During the pick-up step the substrate is lifted off the other elongated transport elements by either moving up the elongated transport elements or by moving down the other elongated transport elements. During the set-down step the substrate is set down on the other elongated transport elements by moving down the elongated transport elements and/or by moving up the other elongated transport elements. The position of the substrate in respect to the other elongated transport elements after the set-down step is laterally shifted in regard to its position before the pick-up step. In this way pick-up/set-down cycles or move-up/move-down cycles produce a stepwise lateral shift of the substrate. In this embodiment either the elongated transport elements or the other elongated transport elements may be stationary.

In a second embodiment the lateral movement of the elongated transport elements happens continuously and simultaneously to the moving forward of the substrate. In this way a smooth and jerk-free movement is ensured. Also the need for a more or less sophisticated control system of the step-wise lateral movement disappears.

In another embodiment the elongated transport elements extend along a longitudinal direction which is basically parallel to the transport direction of the substrate. This longitudinal direction may form an angle with the transport direction in such a way that the lateral shift in respect to the substrate is at least partly caused by the longitudinal movement of the elongated transport elements in longitudinal direction.

One or several additional elongated transport elements which move along an other longitudinal direction which crosses the longitudinal direction may be employed. By this way a net-like structure is produced which moves the substrate forward. The mesh size of this net like structure which is determined by the number of transport elements as well as by the distances between them may be chosen according to the specific process requirements.

In another embodiment the substrate is guided in transport direction by guide elements. If, as in an embodiment described above, the longitudinal direction in which the elongated transport elements extend forms an angle with the transport direction of the substrate the use of guide elements can ensure that a movement of the elongated transport elements in longitudinal direction results in a forward movement of the substrate in transport direction as well as a lateral shift of the elongated transport elements in respect to the substrate. By choosing the geometry accordingly a lateral shift depending on the movement in longitudinal direction can be achieved. A control system for separated movements is not necessary.

One or more of the guide elements may also move in transport direction alongside the substrate. This will avoid rubbing between the substrate and the guide elements which otherwise could cause abrasion of the substrate or even lead to its destruction by jamming.

In another embodiment strands are used as elongated transport elements. These might be wires made of metal or ceramics. Alternatively other suitable materials may be used for the elongated transport elements as e.g. metal or ceramic rods. The use of strands, especially wires has their advantage in in-line processes as vacuum locks and other vacuum devices can be designed having a low volume as degassing only occurs limitedly. Due to swifter evacuation of the vacuum devices a larger throughput may be realized. The reason for the lesser evacuation volume is that no extra substrate carriers have to be transported into the vacuum device together with the substrates. Because of this the vacuum device itself may be designed having smaller dimensions. Additionally no degassing of the carrier will occur which will accelerate the evacuation process.

In a modification of this embodiment each of the strands forms a closed loop. These endless loops of strands may be realized by means of guide reels.

In another modification of this embodiment the strands are mounted onto reels in a way that transporting the substrate may be performed by winding the strands off one reel and winding them up onto another reel. By this way forming loops can be avoided. The strands might be used only once. Alternatively the strands can be designed for multiple use either e.g. in a way that the winding off one reel and winding up onto another reel is reversed e.g. in a production pause during which no substrate transport is necessary or by swapping the reels.

In the context of this invention substrate is any member to be coating with a material. One embodiment uses a semiconductor wafer as substrate which is coated with a metal layer. In a modification of this embodiment the substrate is a silicon wafer which has been or will be processed into a solar cell.

To illustrate the scope of the application a detailed discussion of the accompanying drawings follows.

### DRAWINGS—FIGURES

FIG. 1a is a bird's-eye view of a substrate supported by several elongated transport elements which extend parallel to the transport direction;

FIG. 1b is a sectional view along line Ib-Ib of FIG. 1a;

FIG. 2a is a view of the substrate between guide elements being transported by means of elongated transport elements which form an angle with the transport direction;

FIG. 2b is a sectional view along line IIb-IIb of FIG. 2a;

FIG. 3a is a view of an embodiment for substrate transport with elongated transport elements arranged crosswise;

FIG. 3b is a sectional view along line IIIb-IIIb of FIG. 3a and

FIG. 4 is a schematic view of a deposition device with a substrate supported by elongated transport elements.

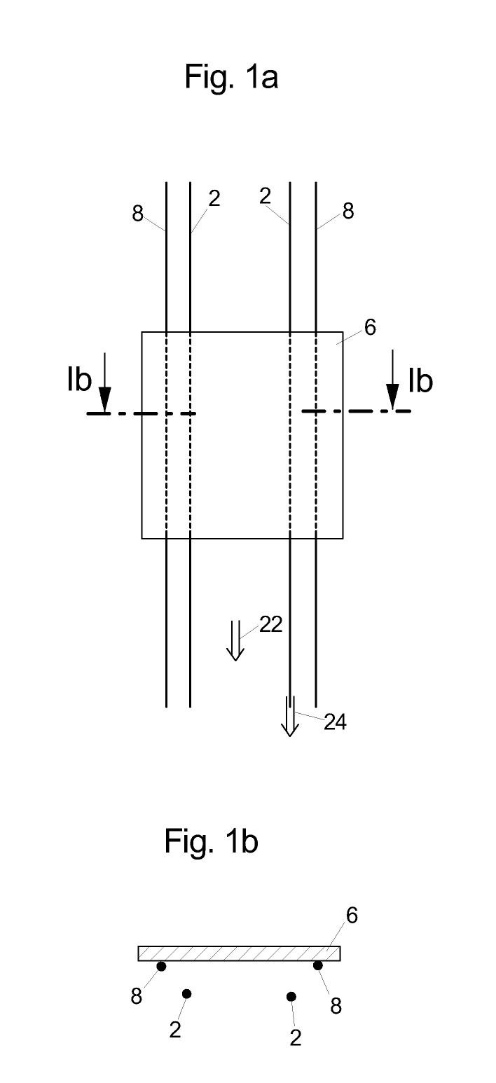

The assembly shown in FIGS. 1a and 1b comprises two elongated transport elements 2 as well as two other elongated transport elements 8 and a substrate 6. Shown here is the state of the assembly where the two other elongated transport elements 8 are in contact with the substrate carrying it while the elongated transport elements 2 are lowered and are detached from the substrate 6.

This assembly can be used for illustrating a method of transport of prior art as well as a method according to an embodiment of the invention. In the prior art method the transport elements 2, 8 move, as seen in the bird's-eye view of FIG. 1a in or contrary to the substrate transport direction 22 which in this case is parallel to a longitudinal direction 24 in which the transport elements 2, 8 extend. To move the substrate 6 in substrate transport direction 22 the two elongated transport elements 2 are lifted in respect to the two other elongated transport elements 8 so that they take up the substrate. The substrate 6 is then moved forwards by a movement of the elongated transport elements 2 in longitudinal direction 24. After this the two elongated transport elements 2 are lowered again in respect to the other elongated transport elements 8 so that they place the substrate 6 onto the other elongated transport elements 8 as shown in FIG. 1b. In this state the elongated transport elements 2 are moved contrary to the longitudinal direction 24. At the same time the other elongated transport elements 8 can be moved in longitudinal direction 24 transporting the substrate 6. This process is repeated in cycles. The lowering and lifting of the transport elements 2, 8 may consist of a relative movement only during which one pair of transport elements 2 or 8 remains stationary.

In the method according to an embodiment of the invention a lateral shift of the elongated transport elements 2 in respect to the substrate occurs which is directed laterally to the substrate transport direction 22. For example the elongated transport elements 2 in the state shown in FIG. 1b may be moved to the left or to the right before they take up the substrate 6 again. During the cycles of picking up and setting down the substrate 6 the elongated transport elements 2 may e.g. move in turn to the left and to the right so that during layer deposition of the substrate from below by means of a vapor source not shown in FIG. 1b the shading caused by the elongated transport elements 2 will not permanently affect the same areas of the substrate 6 surface.

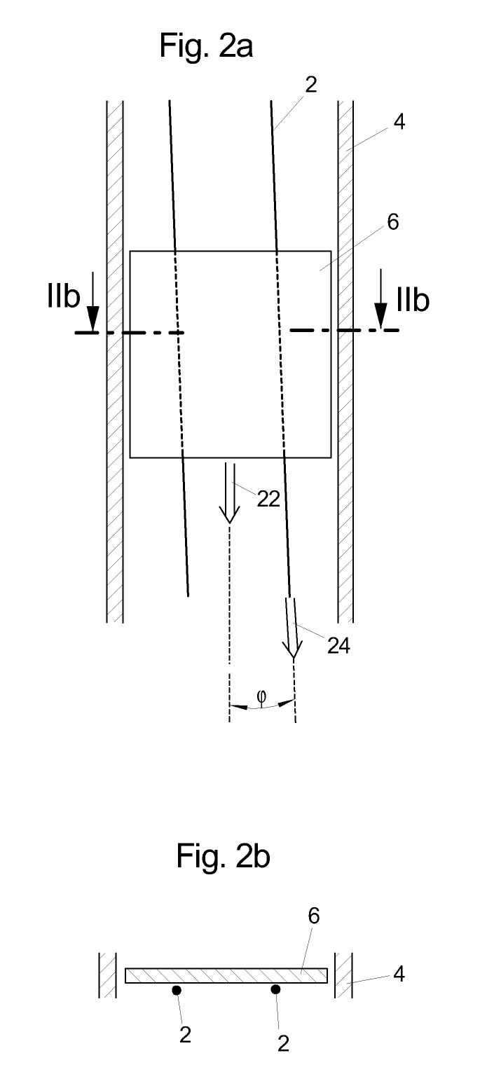

The FIGS. 2a and 2b show in bird's-eye view and sectional view along line IIb-IIb an assembly illustrating another embodiment of the invention. Here the elongated transport elements 2 are arranged in a manner that the direction in which they extend, the longitudinal direction 24 forms an angle φ with the substrate transport direction 22 in which the substrate 6 is transported. In the case shown the elongated transport elements 2 are in permanent touch with the substrate 6 and move in longitudinal direction 24. Additionally guide elements 4 are used for preventing lateral shifting of the substrate out of substrate transport direction 22. By this guidance the substrate 6 is moved in a manner causing a relative movement between itself and the elongated transport elements 2.

Here the guide elements 4 are realized as guide rails which extend beyond the length of the substrate 6 and are positioned stationary. Alternatively the guide elements 4 may be moved alongside the substrate 6 with the same or approximately the same velocity. In this case shorter guide elements 4 might suffice for lateral guiding of the substrate 6 and they might not have to be elongated in substrate transport direction 22.

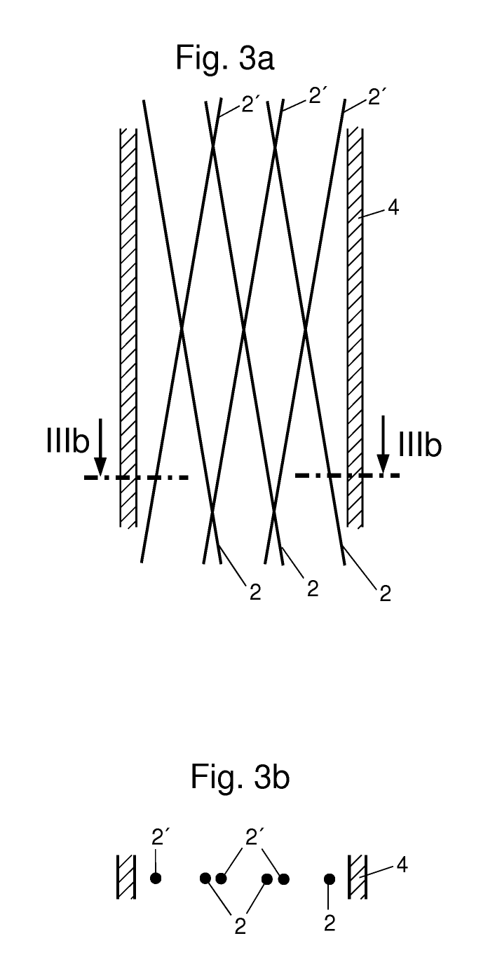

In the assembly shown in FIGS. 2a and 2b the angle φ and/or the transport path along which the substrate 6 is to be transported have to be small enough for the substrate 6 not to fall off the elongated transport elements 2 at the end of the transport path. In a modified embodiment with otherwise equal parameters additional elongated transport elements 2′ may be incorporated. These additional elongated transport elements 2′ extend along an other longitudinal direction 24′ forming an angle with the longitudinal direction 24 of the elongated transport elements 2. Such an assembly is shown in FIGS. 3a and 3b without the substrate 6.

As shown in FIG. 3a the elongated transport elements 2 and the additional elongated transport elements 2′ form a net-shaped structure on which the substrate 6 is moved forwards in substrate transport direction 22. Shown here are only two sets each consisting of three transport elements 2, 2′. If needed, further transport elements in the same or different angles may be included. Additionally suitable choosing of parameters like angle φ, number and positioning of transport elements 2, 2′ and their velocities can ensure that no or only minor force is exerted onto the guide elements 4 by the substrate 6. With suitable adjustment the guide elements 4 might even be omitted without the risk of the substrate 6 significantly moving laterally to the substrate transport direction 22.

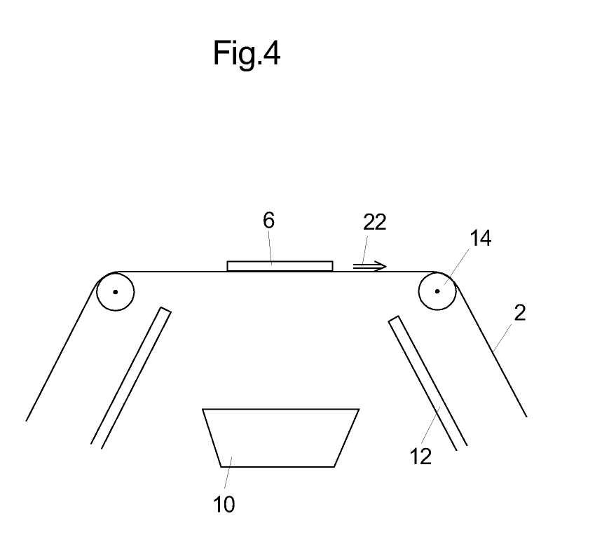

Finally FIG. 4 shows a schematic view of an assembly for depositing layers onto the substrate by vapor phase deposition. The substrate 6 is passed over a crucible acting as vapor source 10 which contains the material to be deposited onto the substrate 6. Shields 12 keep other parts of the assembly as e.g. guide reels 14 from being coated with the vapor.

The aim of the guide reels 14 is to position the elongated transport elements 2 in a way suitable for transporting the substrate 6. In the embodiment shown in FIGS. 2a and 2b the guide reels 14 may be positioned rotated in the substrate plane by the angle φ compared to the illustration shown in FIG. 4. The elongated transport elements 2 which might be wires made of metal or ceramics are guided through a deposition device comprising the vapor source 10 (to ensure clarity other components of the deposition device are not shown in FIG. 4). Apart from this the guide reels 14 might be used to ensure that the elongated transport elements 2 have enough tension in the area in proximity to the vapor source 10. Likewise it is also thinkable to design the elongated transport elements 2 to revolve. After leaving the deposition zone and running through a reversal device they would enter the deposition zone again. During reversal a mechanical and/or chemical cleansing device might be introduced which would remove coating deposited during the vapor deposition process from the transport elements 2.

Apart from the described physical vapor deposition with a crucible as vapor source 10 any other coating or deposition process using solid, gaseous or even liquid phase sources might be used in conjunction with the described transport method.

### DRAWINGS—REFERENCE NUMERALS

2 elongated transport elements

2′ additional elongated transport elements

4 guide elements

6 substrate

8 other elongated transport elements

10 vapor source

12 shield

14 guide reel

22 substrate transport direction

24 longitudinal direction

24′ other longitudinal direction

1. Method for transporting a substrate, comprising:
supporting said substrate by one or several elongated transport elements,
moving said substrate forwards in a substrate transport direction by a movement of said elongated transport elements,
performing a lateral shift of said elongated transport elements in regard to said substrate whereby said lateral shift is directed laterally to said substrate transport direction.

2. The method according to claim 1, wherein said lateral shift of said elongated transport elements is performed stepwise.

3. The method according to claim 2, wherein said lateral shift of said elongated transport elements comprises a displacement movement during which said elongated transport elements detach from said substrate.

4. The method according to claim 3, wherein said lateral shift of said elongated transport elements comprises setting down said substrate onto one or several other elongated transport elements.

5. The method according to claim 4 comprising:
a pick-up step during which said substrate is detached from said other elongated transport elements by moving upwards said elongated transport elements and/or by moving downwards said other elongated transport elements
and a set-down step during which said substrate is set down onto said other transport elements by moving downwards said elongated transport elements and/or by moving upwards said other elongated transport elements
in a way that the position of said substrate in regard to said other elongated transport elements after said set-down step is laterally shifted in respect to the position of said substrate in regard to said other elongated transport elements before said pick-up step.

6. The method according to claim 1, wherein said lateral shift of said elongated transport elements happens continuously and simultaneously with the moving forwards of said substrate.

7. The method according to claim 1, wherein said elongated transport elements extend along a longitudinal direction which is basically parallel to said substrate transport direction.

8. The method according to claim 1, wherein said elongated transport elements extend along a longitudinal direction which forms an angle with said substrate transport direction in a way that said lateral shift in regard to said substrate is at least partly caused by the longitudinal movement of said elongated transport elements in said longitudinal direction.

9. The method according to claim 8, comprising one or several additional elongated transport elements which extend along an other longitudinal direction which crosses said longitudinal direction.

10. The method according to claim 1, wherein said substrate is guided in said substrate transport direction by at least one guide element.

11. The method according to claim 10, wherein at least one of said guide elements moves in said substrate transport direction alongside said substrate.

12. The method according to claim 1, wherein said elongated transport elements comprise strands.

13. The method according to claim 12, wherein said strands comprise wires of metal and/or ceramics.

14. The method according to claim 12, wherein at least one of said strands forms a closed loop.

15. The method according to claim 12, wherein said strands are wound onto reels in a way that substrate transport can be performed by unwinding said strands from one of the reels and winding them up onto another one of the reels.

16. Device for transporting a substrate, comprising:
one or several elongated transport elements for supporting said substrate,
transport means for moving said elongated transport elements in a way that said substrate is moved forwards in a substrate transport direction
characterized in that said elongated transport elements are formed in a way that a lateral shift of said elongated transport elements in respect to said substrate directed in a direction lateral to said substrate transport direction is possible.
